(19) United States
(12) Patent Application Publication
(10) Pub. No.: US 2019/0345296 A1
(43) Pub. Date: Nov. 14, 2019

(54) PROCESS FOR THE MANUFACTURE OF THERMOPLASTIC POLYMER PARTICLES, THERMOPLASTIC POLYMER PARTICLES MADE THEREBY, AND ARTICLES MADE THEREFROM

(71) Applicant: SABIC Global Technologies B.V., Bergen op Zoom (NL)

(72) Inventors: Viswanathan Kalyanaraman, Newburgh, IN (US); Brian Price, Evansville, IN (US)

(21) Appl. No.: 16/465,257

(22) PCT Filed: Dec. 1, 2017
(86) PCT No.: PCT/US2017/064138

§ 371 Date: May 30, 2019

Related U.S. Application Data
(60) Provisional application No. 62/430,680, filed on Dec. 6, 2016.

(51) Int. Cl. C08J 3/14

(52) U.S. Cl. CPC C08J 3/14; C08J 2367/00; C08J 2381/06; C08J 2377/00; C08J 2379/08; C08J 2369/00

(57) ABSTRACT

A process for the manufacture of thermoplastic polymer particles in a yield of greater than 70% is described. The process includes dissolving a thermoplastic polymer in an organic solvent capable of dissolving the polymer to form a solution, emulsifying the solution by combining the solution with water and a surfactant to form an emulsion, removing the organic solvent to form a slurry, and recovering thermoplastic polymer particles having a diameter of less than 150 micrometers and in a yield of greater than 70%. The water is present in the emulsion in an amount of 5 to less than 50 weight percent. The thermoplastic polymer particles exhibit a combination of size characteristics. Thermoplastic polymer particles and articles prepared therefrom are also described.

### BACKGROUND

High performance polymers, such as polyetherimides, can be made into powders by emulsifying the polymer in an organic solvent, and subsequently removing the organic solvent from the emulsion through distillation. Additional information relevant to such methods can be found, for example, in U.S. Pat. No. 6,528,611. However, particles made by such an emulsion distillation process can result in a poor yield of particles having the desired particle size characteristics. U.S. Pat. No. 9,181,395 discloses that spherical, ultra-fine particles can be prepared via an emulsion process in high yields, and having a volume-based diameter of less than 75 micrometers. The particles produced by the method disclosed in U.S. Pat. No. 9,181,395 have a ratio of average volume-based diameter and average number-based diameter of more than 5.0, and particle distribution spans (e.g., number or volume-based particle distribution spans) of greater than 2.0.

For some applications, such as additive manufacturing, spherical particles having a ratio of average volume-based diameter and average number-based diameter of less than 2.0 can be preferred. It can also be preferred to produce particles having particle size distribution spans of less than 2.0 for some applications. Jet milling represents another known process for producing polymer particles. Particles produced by jet milling can in some instances exhibit a ratio of average volume-based diameter and average number-based diameter of less than 2.0, as well as a particle size distribution span of less than 2.0; however the particles produced by a jet milling process are not spherical.

Accordingly, there remains a continuing need for an optimized process that can provide high performance polymer particles in high yields and having desirable particle size characteristics.

### BRIEF DESCRIPTION

A process for the manufacture of thermoplastic polymer particles in a yield of greater than 70% comprises dissolving a thermoplastic polymer in an organic solvent capable of dissolving the polymer to form a solution; emulsifying the solution by combining the solution with water and a surfactant to form an emulsion, wherein the water is present in the emulsion in an amount of 5 to less than 50 weight percent, or 5 to 45 weight percent, or 5 to 35 weight percent, or 5 to 30 weight percent, or 5 to 25 weight percent, or 7 to 20 weight percent, or 7 to 15 weight percent, based on the total weight of the water and the organic solvent; removing the organic solvent from the emulsion to form a slurry; and recovering thermoplastic polymer particles in a yield of greater than 70%, wherein the particles exhibit: an average number-based diameter (Dn100), volume-based diameter (Dv100), or both, of less than 150 micrometers, or 0.1 to less than 150 micrometers, or 1 to 100 micrometers, or greater than 10 to 75 micrometers or less; an average volume-based diameter (Dv50) to average number-based diameter (Dn50) ratio of less than 2.0, preferably less than 1.75, more preferably less than 1.5, even more preferably less than 1.4; a volume-based particle size distribution span of less than 2.0, preferably less than 1.5, more preferably less than 1.0; and a number-based particle size distribution span of less than 2.0, preferably less than 1.5, more preferably less than 1.0.

Thermoplastic polymer particles prepared by the process are also described.

A thermoplastic polymer powder comprises thermoplastic polymer particles having a diameter of less than 150 micrometers, wherein the particles have an average volume-based diameter (Dv50) to average number-based diameter (Dn50) ratio of less than 2.0, preferably less than 1.75, more preferably less than 1.5; a volume-based particle size distribution of less than 2.0, preferably less than 1.5, more preferably less than 1.0; a number-based particle size distribution of less than 2.0, preferably less than 1.5, more preferably less than 1.0; and a sphericity of greater than 0.9.

An article prepared from the thermoplastic polymer particles is also described.

The above described and other features are exemplified by the following figures and detailed description.

### BRIEF DESCRIPTION OF THE DRAWINGS

The following figures are of exemplary embodiments.

FIG. 1 shows non-overlapping volume- and number-based particle size distribution spans obtained for example 14.

FIG. 2 shows overlapping narrow volume- and number-based particle size distribution spans obtained for example 11.

FIG. 3 shows overlapping narrow volume- and number-based particle size distribution spans obtained for example 12.

FIG. 4 shows an optical micrograph of spherical polymer particles according to example 11.

FIG. 5 shows an optical micrograph of spherical polymer particles according to example 12.

### DETAILED DESCRIPTION

Disclosed herein is a process for the manufacture of thermoplastic polymer particles having narrow and overlapping particle size distributions in a yield of greater than 70%. The present inventors have unexpectedly discovered that the relative amounts of water and organic solvent used to prepare the emulsion from which the particles can be obtained can have a significant effect on the size characteristics of the resulting polymer particles. Advantageously, the polymer particles provided by the method described herein can have an average volume-based diameter (Dv50) to average number-based diameter (Dn50) ratio of less than 2.0, a volume-based particle size distribution span of less than 2.0, a number-based particle size distribution span of less than 2.0, and a sphericity of greater than 0.9.

Accordingly, one aspect of the present disclosure is a process for the manufacture of thermoplastic polymer particles. The process comprises dissolving a thermoplastic polymer in an organic solvent capable of dissolving the polymer to form a solution.

As used herein, the term “thermoplastic” refers to a material that is plastic or deformable, melts to a liquid when heated, and freezes to a brittle, glassy state when cooled sufficiently. Thermoplastics are typically high molecular weight polymers. Examples of thermoplastic polymers that can be used include, for example, polycarbonates (including polycarbonate copolymers such as polycarbonate-siloxanes, polycarbonate-esters, and polycarbonate-ester-siloxanes), polyimides (including copolymers such as polyimide-siloxane copolymers), polyetherimides (including copolymers such as polyetherimide-siloxane copolymers), polysulfone, polyethersulfone, polyphenylene sulfone, polyarylene ether, polyarylate, polyamide, polyamideimide, polyester, or a combination comprising at least one of the foregoing. In some embodiments, the thermoplastic polymer preferably comprises polycarbonate, polyetherimide, polysulfone, or a combination comprising at least one of the foregoing. In an embodiment, the thermoplastic polymer comprises polyetherimide.

“Polycarbonate” as used herein means a polymer or copolymer having repeating structural carbonate units of formula (1)

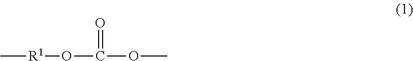

wherein at least 60 percent of the total number of R¹ groups are aromatic, or each R¹ contains at least one C₆₋₃₀ aromatic group. Specifically, each R¹ can be derived from a dihydroxy compound such as an aromatic dihydroxy compound of formula (2) or a bisphenol of formula (3).

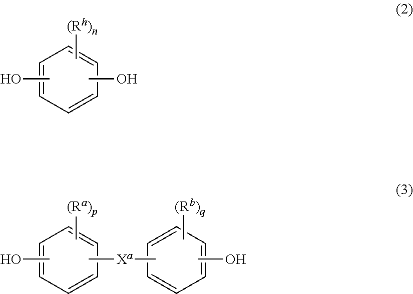

In formula (2), each R^{h} is independently a halogen atom, for example bromine, a C₁₋₁₀ hydrocarbyl group such as a C₁₋₁₀ alkyl, a halogen-substituted C₁₋₁₀ alkyl, a C₆₋₁₀ aryl, or a halogen-substituted C₆₋₁₀ aryl, and n is 0 to 4.

In formula (3), R^{a} and R^{h} are each independently a halogen, C₁₋₁₂ alkoxy, or C₁₋₁₂ alkyl, and p and q are each independently integers of 0 to 4, such that when p or q is less than 4, the valence of each carbon of the ring is filled by hydrogen. In an embodiment, p and q is each 0, or p and q is each 1, and R^{a} and R^{h} are each a C₁₋₃ alkyl group, specifically methyl, disposed meta to the hydroxy group on each arylene group. X^{a} is a bridging group connecting the two hydroxy-substituted aromatic groups, where the bridging group and the hydroxy substituent of each C₆ arylene group are disposed ortho, meta, or para (specifically para) to each other on the C₆ arylene group, for example, a single bond, —O—, —S—, —S(O)—, —S(O)₂—, —C(O)—, or a C₁₋₁₈ organic group, which can be cyclic or acyclic, aromatic or non-aromatic, and can further comprise heteroatoms such as halogens, oxygen, nitrogen, sulfur, silicon, or phosphorous. For example, X^{a} can be a substituted or unsubstituted C₃₋₁₈ cycloalkylidene; a C₁₋₂₅ alkylidene of the formula —C(R^{c})(R^{d})— wherein R^{c} and R^{d} are each independently hydrogen, C₁₋₁₂ alkyl, C₁₋₁₂ cycloalkyl, C₇₋₁₂ arylalkyl, C₁₋₁₂ heteroalkyl, or cyclic C₇₋₁₂ heteroarylalkyl; or a group of the formula —C(═R^{e})— wherein R^{c} is a divalent C₁₋₁₂ hydrocarbon group.

Examples of bisphenol compounds include 4,4′-dihydroxybiphenyl, 1,6-dihydroxynaphthalene, 2,6-dihydroxynaphthalene, bis(4-hydroxyphenyl)methane, bis(4-hydroxyphenyl)diphenylmethane, bis(4-hydroxyphenyl)-1-naphthylmethane, 1,2-bis(4-hydroxyphenyl)ethane, 1,1-bis(4-hydroxyphenyl)-1-phenylethane, 2-(4-hydroxyphenyl)-2-(3-hydroxyphenyl)propane, bis(4-hydroxyphenyl)phenylmethane, 2,2-bis(4-hydroxy-3-bromophenyl)propane, 1,1-bis(hydroxyphenyl)cyclopentane, 1,1-bis(4-hydroxyphenyl)cyclohexane, 1,1-bis(4-hydroxyphenyl)isobutene, 1,1-bis(4-hydroxyphenyl)cyclododecane, trans-2,3-bis(4-hydroxyphenyl)-2-butene, 2,2-bis(4-hydroxyphenyl)adamantane, alpha,alpha′-bis(4-hydroxyphenyl)toluene, bis(4-hydroxyphenyl)acetonitrile, 2,2-bis(3-methyl-4-hydroxyphenyl)propane, 2,2-bis(3-ethyl-4-hydroxyphenyl)propane, 2,2-bis(3-n-propyl-4-hydroxyphenyl)propane, 2,2-bis(3-isopropyl-4-hydroxyphenyl)propane, 2,2-bis(3-sec-butyl-4-hydroxyphenyl)propane, 2,2-bis(3-t-butyl-4-hydroxyphenyl)propane, 2,2-bis(3-cyclohexyl-4-hydroxyphenyl)propane, 2,2-bis(3-allyl-4-hydroxyphenyl)propane, 2,2-bis(3-methoxy-4-hydroxyphenyl)propane, 2,2-bis(4-hydroxyphenyl)hexafluoropropane, 1,1-dichloro-2,2-bis(4-hydroxyphenyl)ethylene, 1,1-dibromo-2,2-bis(4-hydroxyphenyl)ethylene, 1,1-dichloro-2,2-bis(5-phenoxy-4-hydroxyphenyl)ethylene, 4,4′-dihydroxybenzophenone, 3,3-bis(4-hydroxyphenyl)-2-butanone, 1,6-bis(4-hydroxyphenyl)-1,6-hexanedione, ethylene glycol bis(4-hydroxyphenyl)ether, bis(4-hydroxyphenyl)ether, bis(4-hydroxyphenyl)sulfide, bis(4-hydroxyphenyl)sulfoxide, bis(4-hydroxyphenyl)sulfone, 9,9-bis(4-hydroxyphenyl)fluorene, 2,7-dihydroxypyrene, 6,6′-dihydroxy-3,3,3′,3′-tetramethylspiro(bis)indane (“spirobiindane bisphenol”), 3,3-bis(4-hydroxyphenyl)phthalimide, 2,6-dihydroxydibenzo-p-dioxin, 2,6-dihydroxythianthrene, 2,7-dihydroxyphenoxathin, 2,7-dihydroxy-9,10-dimethylphenazine, 3,6-dihydroxydibenzofuran, 3,6-dihydroxydibenzothiophene, and 2,7-dihydroxycarbazole; resorcinol, substituted resorcinol compounds such as 5-methyl resorcinol, 5-ethyl resorcinol, 5-propyl resorcinol, 5-butyl resorcinol, 5-t-butyl resorcinol, 5-phenyl resorcinol, 5-cumyl resorcinol, 2,4,5,6-tetrafluoro resorcinol, 2,4,5,6-tetrabromo resorcinol, or the like; catechol; hydroquinone; substituted hydroquinones such as 2-methyl hydroquinone, 2-ethyl hydroquinone, 2-propyl hydroquinone, 2-butyl hydroquinone, 2-t-butyl hydroquinone, 2-phenyl hydroquinone, 2-cumyl hydroquinone, 2,3,5,6-tetramethyl hydroquinone, 2,3,5,6-tetra-t-butyl hydroquinone, 2,3,5,6-tetrafluoro hydroquinone, 2,3,5,6-tetrabromo hydroquinone, or the like.

Specific dihydroxy compounds include resorcinol, 2,2-bis(4-hydroxyphenyl) propane (“bisphenol A” or “BPA”), 3,3-bis(4-hydroxyphenyl) phthalimidine, 2-phenyl-3,3′-bis(4-hydroxyphenyl) phthalimidine (also known as N-phenyl phenolphthalein bisphenol, “PPPBP”, or 3,3-bis(4-hydroxyphenyl)-2-phenylisoindolin-1-one), 1,1-bis(4-hydroxy-3-methylphenyl)cyclohexane, and 1,1-bis(4-hydroxyphenyl)-3,3,5-trimethylcyclohexane (isophorone bisphenol).

Exemplary polycarbonates can include, for example, a linear homopolymer containing bisphenol A carbonate units (BPA-PC), commercially available under the trade name LEXAN from SABIC; or a branched, cyanophenol end-capped bisphenol A homopolycarbonate produced via interfacial polymerization, containing 3 mol % 1,1,1-tris(4-hydroxyphenyl)ethane (THPE) branching agent, commercially available under the trade name LEXAN CFR from SABIC. A combination of a linear polycarbonate and a branched polycarbonate can be used. It is also possible to use a polycarbonate copolymer or interpolymer rather than a homopolymer. Polycarbonate copolymers can include copolycarbonates comprising two or more different types of carbonate units, for example units derived from BPA and PPPBP (commercially available under the trade name XHT from SABIC). Combinations comprising any of the above materials can be used.

Polyetherimides can comprise more than 1, for example 2 to 1000, or 5 to 500, or 10 to 100 structural units of formula (4)

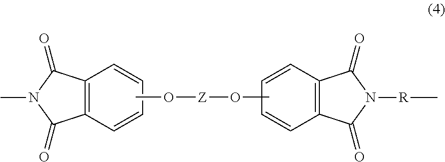

wherein the R groups are each independently the same or different, and are a substituted or unsubstituted C₆₋₂₀ aromatic hydrocarbon group, a substituted or unsubstituted, straight or branched chain C₄₋₂₀ alkylene group, a substituted or unsubstituted C₃₋₈ cycloalkylene group, or a combination comprising at least one of the foregoing. In some embodiments R is divalent group of one or more of the following formulas (5)

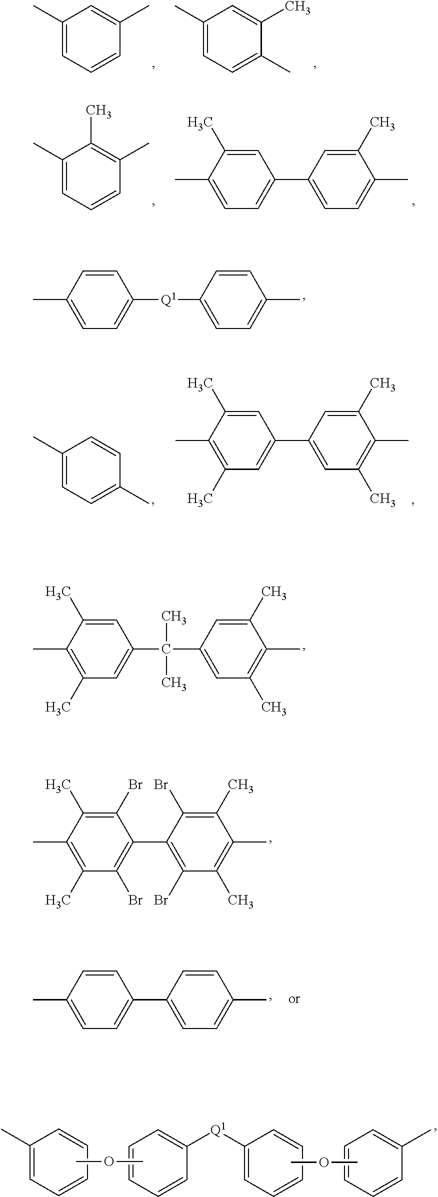

wherein Q¹ is —O—, —S—, —C(O)—, —SO₂—, —SO—, —P(R^{a})(═O)— wherein R^{a} is a C₁₋₈ alkyl or C₆₋₁₂ aryl, —C_{y}H_{2y}— wherein y is an integer from 1 to 5 or a halogenated derivative thereof (which includes perfluoroalkylene groups), or —(C₆H₁₀)_{z}— wherein z is an integer from 1 to 4. In some embodiments R is m-phenylene, p-phenylene, or a diarylene sulfone, in particular bis(4,4′-phenylene)sulfone, bis(3,4′-phenylene)sulfone, bis(3,3′-phenylene)sulfone, or a combination comprising at least one of the foregoing. In some embodiments, up to 10 mole percent of the R groups contain sulfone groups, and in other embodiments no R groups contain sulfone groups.

Further in formula (4), the divalent bonds of the —O—Z—O— group are in the 3,3′, 3,4′, 4,3′, or the 4,4′ positions, and Z is an aromatic C₆₋₂₄ monocyclic or polycyclic moiety optionally substituted with 1 to 6 C₁₋₈ alkyl groups, 1 to 8 halogen atoms, or a combination comprising at least one of the foregoing, provided that the valence of Z is not exceeded. Exemplary groups Z include groups of formula (6)

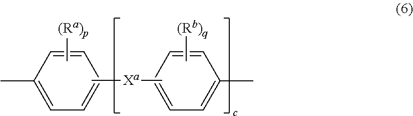

wherein R^{a} and R^{b} are each independently the same or different, and are a halogen atom or a monovalent C₁₋₆ alkyl group, for example; p and q are each independently integers of 0 to 4; c is 0 to 4; and X^{a} is a bridging group connecting the hydroxy-substituted aromatic groups, where the bridging group and the hydroxy substituent of each C₆ arylene group are disposed ortho, meta, or para (specifically para) to each other on the C₆ arylene group. The bridging group X^{a} can be a single bond, —O—, —S—, —S(O)—, —S(O)₂—, —C(O)—, or a C₁₋₁₈ organic bridging group. The C₁₋₁₈ organic bridging group can be cyclic or acyclic, aromatic or non-aromatic, and can further comprise heteroatoms such as halogens, oxygen, nitrogen, sulfur, silicon, or phosphorous. The C₁₋₁₈ organic group can be disposed such that the C₆ arylene groups connected thereto are each connected to a common alkylidene carbon or to different carbons of the C₁₋₁₈ organic bridging group. A specific example of a group Z is a divalent group of formula (6a)

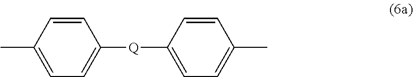

wherein Q is —O—, —S—, —C(O)—, —SO₂—, —SO—, —P(R^{a})(═O)— wherein R^{a} is a C₁₋₈ alkyl or C₆₋₁₂ aryl, or —C_{y}H_{2y}— wherein y is an integer from 1 to 5 or a halogenated derivative thereof (including a perfluoroalkylene group). In a specific embodiment Z is a derived from bisphenol A, such that Q in formula (6a) is 2,2-isopropylidene.

In some embodiments in formula (4), R is m-phenylene or p-phenylene and Z is a divalent group of formula (6a). Alternatively, R is m-phenylene or p-phenylene and Z is a divalent group of formula (6a) and Q is 2,2-isopropylidene (i.e., Z is 4,4′-diphenylene isopropylidene).

In some embodiments, the polyetherimide can be a linear, branched or hyperbranched polyetherimide. Branched or hyperbranched polyetherimides can be prepared by selecting appropriate multifunctional monomers, for example monomers having more than two functional groups. In some embodiments, the polyetherimide can have end groups that can further react. Examples of such end groups include maleic anhydride, nadic anhydride, methyl nadic anhydride, citraconic anhydride, phenylethynyl phthalic anhydride, 4-ethynyl phthalic anhydride, and hydroxyl benzoic acid end groups, which can be introduced to the polyetherimide, for example, through the use of chain stoppers or end-capping agents which are generally known.

Polysulfones include those comprising repeating units including one or more sulfone linkages. In some embodiments, the polysulfone comprises repeating structural units having the formula (7)

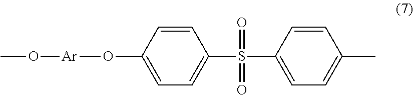

wherein Ar is independently at each occurrence a substituted or unsubstituted divalent organic group, for example a substituted or unsubstituted C₆₋₂₀ aromatic hydrocarbon group. In some embodiments, Ar is a divalent group of the formula

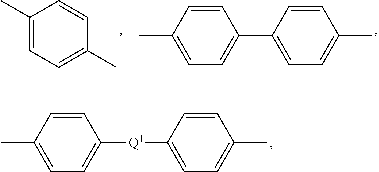

wherein Q¹ is —O—, —S—, —C(O)—, —SO₂—, —SO—, —P(R^{a})(═O)— wherein R^{a} is a C₁₋₈ alkyl or C₆₋₁₂ aryl, —C_{y}H_{2y}— wherein y is an integer from 1 to 5 or a halogenated derivative thereof (which includes perfluoroalkylene groups). In some embodiments, Q¹ is —O—, —SO₂—, or —C_{y}H_{2y}— wherein y is an integer from 1 to 5. In some embodiments, Q¹ is a 2,2-isopropylidene group (e.g., Ar is a group derived from bisphenol A).

Exemplary polysulfones can include those available under the trade name UDEL or RADEL-A, VERADEL, RADEL-R, and ACUDEL, each available from Solvay Specialty Polymers, LLC.

The organic solvent can be any organic solvent that is capable of dissolving the polymer to form the solution. In some embodiments, the organic solvent has a boiling point of less than 100° C. The organic solvent is further substantially immiscible with water. An organic solvent that is substantially immiscible with water as defined herein can refer to an organic solvent that has a solubility of less than 5 weight percent in water. For example, the organic solvent can have a solubility of less than 5 grams per 100 grams of water, for example, less than 3 grams per 100 grams of water. In some embodiments, the organic solvent is immiscible with water. In some embodiments, the organic solvent comprises methylene chloride, chloroform, 1,1-dichloroethane, 1,2-dichloroethane, 1,1,1-trichloroethane, or a combination comprising at least one of the foregoing. In a specific embodiment, the organic solvent comprises dichloromethane.

In some embodiments, the organic solvent and the thermoplastic polymer can be combined to provide a solution having a solids content (i.e., weight percent of thermoplastic polymer, based on the total weight of the solution) of greater than 5 weight percent, or greater than 10 weight percent, or greater than 15 weight percent. A solids content of less than 90 weight percent can be used.

The resulting solution is emulsified by combining the solution with water and a surfactant to form an emulsion. The organic solvent can be subsequently removed to form a slurry.

In some embodiments the water can be deionized water. The water is advantageously combined with the solution in order to provide the emulsion such that the water is present in the emulsion in an amount of 5 to less than 50 weight percent, or 5 to 45 weight percent, or 5 to 35 weight percent, or 5 to 30 weight percent, or 5 to 25 weight percent, or 7 to 20 weight percent, or 7 to 15 weight percent, based on the total weight of the water and the organic solvent. When the water is present in the emulsion in an amount of 50 weight percent or greater, based on the total weight of the water and the organic solvent, the resulting thermoplastic polymer particles do not exhibit the desired particle size characteristics, as further described below, and as demonstrated in the working examples.

Surfactants suitable for use in the present method can include anionic, cationic, and nonionic surfactants, or combinations thereof. In some embodiments, the surfactant can be a nonionic surfactant. Exemplary nonionic surfactants can include a C₈₋₂₂ aliphatic alcohol ethoxylate having about 1 to about 25 mol of ethylene oxide and having have a narrow homolog distribution of the ethylene oxide (“narrow range ethoxylates”) or a broad homolog distribution of the ethylene oxide (“broad range ethoxylates”); and preferably C₁₀₋₂₀ aliphatic alcohol ethoxylates having about 2 to about 18 mol of ethylene oxide. Examples of commercially available nonionic surfactants of this type are TERGITOL 15-S-9 (a condensation product of C₁₁₋₁₅ linear secondary alcohol with 9 moles ethylene oxide), TERGITOL 24-L-NMW (a condensation product of C₁₂₋₁₄ linear primary alcohol with 6 moles of ethylene oxide) with a narrow molecular weight distribution from Dow Chemical Company. This class of product also includes the GENAPOL brands of Clamant GmbH.

Other nonionic surfactants that can be used include polyethylene, polypropylene, and polybutylene oxide condensates of C₆₋₁₂ alkyl phenols, for example compounds having 4 to 25 moles of ethylene oxide per mole of C₆₋₁₂ alkylphenol, preferably 5 to 18 moles of ethylene oxide per mole of C₆₋₁₂ alkylphenol. Commercially available surfactants of this type include IGEPAL CO-630, TRITON X-45, X-114, X-100 and X102, TERGITOL TMN-10, TERGITOL TMN-100X, and TERGITOL TMN-6 (all polyethoxylated 2,6,8-trimethyl-nonylphenols or mixtures thereof) from Dow Chemical Corporation, and the Arkopal-N products from Hoechst AG. Still others include the addition products of ethylene oxide with a hydrophobic base formed by the condensation of propylene oxide with propylene glycol. The hydrophobic portion of these compounds preferably has a molecular weight between about 1500 and about 1800 Daltons. Commercially available examples of this class of product are the Pluronic brands from BASF and the Genapol PF trademarks of Hoechst AG. The addition products of ethylene oxide with a reaction product of propylene oxide and ethylenediamine can also be used. The hydrophobic moiety of these compounds consists of the reaction product of ethylenediamine and excess propylene oxide, and generally has a molecular weight of about 2500 to about 3000 Daltons. This hydrophobic moiety of ethylene oxide is added until the product contains from about 40 to about 80 wt % of polyoxyethylene and has a molecular weight of about 5000 to about 11,000 Daltons. Commercially available examples of this compound class are the TETRONIC brands from BASF and the Genapol PN trademarks of Hoechst AG. In some embodiments, the nonionic surfactant is a C₆₋₁₂ alkyl phenol having 4 to 25 moles of ethylene oxide per mole of C₆₋₁₂ alkylphenol, preferably 5 to 18 moles of ethylene oxide per mole of C₆₋₁₂ alkylphenol.

In some embodiments, the surfactant can be a nonionic surfactant comprising a sorbitol derivative, for example a sorbitan ester, or a polyethoxylated sorbitan ester. Examples of commercially available nonionic surfactants of this type are the partial esters of common fatty acids and hexitol anhydrides derived from sorbitol, including SPAN 20 (containing a residue of lauric acid), SPAN 40 (containing a residue of palmitic acid), and SPAN 80 (containing a residue of oleic acid). Suitable polyethoxylated sorbitan esters include TWEEN 20, TWEEN 40, TWEEN 60, TWEEN 65, and TWEEN 80, each of which is commercially available from ICI Americas, Inc. of Wilmington, Del. The TWEEN surfactants are each mixtures of various polyoxyethylene fatty acid esters in liquid form. For example, TWEEN 20 comprises polyoxyethylene (POE) esters of about 60 wt % lauric acid (dodecanoic acid); about 18% myristic acid (tetradecanoic acid); about 7% caprylic acid (octanoic acid) and about 6% capric acid (decanoic acid). TWEEN 40 generally comprises POE esters of about 90% palmitic acid (hexadecanoic acid). TWEEN 60 generally comprises POE esters of about 49% stearic acid (octadecanoic acid) and about 44% palmitic acid. TWEEN 80 generally comprises POE esters of about 69% oleic acid (cis-9-octadecanoic acid); about 3% linoleic acid (linoleic acid); about 3% linolenic acid (9,12,15-octadecatrienoic acid); about 1% stearic acid and about 1% palmitic acid.

In some embodiments, the surfactant is preferably an anionic surfactant. In some embodiments, the anionic surfactant can be, for example, sodium dodecyl benzene sulfonate, sodium lauryl sulfate, ammonium lauryl sulfate, sodium lauryl ether sulfate, sodium myreth sulfate, dioctyl sodium sulfosuccinate, perfluorooctanesulfonate, perfluorobutanesulfonate, linear alkylbenzene sulfonates, sodium lauroyl sarcosinate, also known as sarkosyl, or a combination comprising at least one of the foregoing. In some embodiments, the anionic surfactant comprises sodium dodecyl benzene sulfonate, sodium lauryl sulfate, or a combination comprising at least one of the foregoing. In some embodiments, the anionic surfactant preferably comprises sodium dodecyl benzene sulfonate.

In some embodiments, the surfactant comprises a biopolymer, for example gelatin, carrageenan, pectin, soy protein, lecithin, casein, collagen, albumin, gum arabic, agar, protein, cellulose and derivatives thereof, a polysaccharide and derivatives thereof, starch and derivatives thereof, or the like, or a combination comprising at least one of the foregoing, preferably gelatin. Gelatin is a product obtained by the partial hydrolysis of collagen derived from the skin, white connective tissue, and bones of animals. It is a derived protein comprising various amino acids linked between adjacent imino and carbonyl groups to provide a peptide bond. The amino acid combinations in gelatin provide amphoteric properties, which are responsible for varying isoelectric values, depending somewhat upon the methods of processing. Important physical properties of gelatin such as solubility, swelling, and viscosity show minimum values at the isoelectric point. In some embodiments, the gelatin can be a recombinant gelatin or a plant-based gelatin.

The gelatin surfactant can comprise type A gelatin, type B gelatin, or a combination comprising at least one of the foregoing. Type A gelatin results from acid pretreatment (swelling of the raw material in the presence of acid) and is generally made from frozen pork skins treated in dilute acid (HCl, H₂SO₃, H₃PO₄, or H₂SO₄) at a pH of 1 to 2 for 10 to 30 hours, after which it is water washed to remove excess acid, followed by extraction and drying in the conventional manner. Type B gelatin results from alkali pretreatment (swelling of the raw material in the presence of an alkali) and is generally made from ossein or hide stock which is treated in saturated lime water for 3 to 12 weeks, after which the lime is washed out and neutralized with acid. The adjusted stock is then hot water extracted and dried as with type A. Dry bone is cleaned, crushed, and treated for 10 to 14 days with 4 to 7% HCl to remove the minerals (principally tricalcium phosphate) and other impurities before reaching the stage known as ossein. Dry bone is 13 to 17% gelatin whereas dry ossein is 63 to 70% gelatin. Type A gelatin is characterized by an isoelectric zone between pH 7 and 9, whereas type B gelatin has an isoelectric zone between pH 4.7 and 5.0. Thus the ionic character of the gelatin when used as a surfactant can be selected based on the pH of the second solution. Relative to each other, type A gelatin has less color, better clarity, more brittleness in film form and is faster drying than type B. In some embodiments, the gelatin is type B gelatin.

In other embodiments, the surfactant is a polymeric surfactant such as polyvinyl alcohol, polyvinyl pyrrolidone, polyethylene oxide, and the like.

Combinations of any of the foregoing surfactants can be included in the emulsion. A surfactant can be included in the emulsion in an amount of 0.1 to 10 weight percent, based on the total weight of the surfactant and the water.

In some embodiments, the solution can be agitated upon combination with the water and the surfactant to form the emulsion. For example, agitating to form the emulsion can be achieved by a low or high shear impeller, a low or high shear pump (e.g., a positive displacement pump or a rotary pump), a mixing valve, a low or high shear mixer, an agitator mixer, a paddle mixer, sonication, a rotor-stator mixer, a homogenizer, an emulsification pump, a turbulent mixer, mechanical shaking, hand shaking, and the like, or a combination comprising at least one of the foregoing agitation techniques. In some embodiments, agitating to form the emulsion can be by mechanical shaking. In some embodiments, agitating to form the emulsion can be by use of a high shear mixer. When a high shear mixer is used, speeds of greater than 2,000 rotations per minute, preferably 2,500 to 20,000 rotations per minute, more preferably 2,500 to 10,000 rotations per minute (rpm) can be used. Without wishing to be bound by theory, the shear rate can be correlated to the particle size distribution based on the following formula

γ<R·∇ν·μ,

where γ is the surface tension, R is the particle radius, ∇ν is the shear rate, and μ is the viscosity.

In some embodiments, an anti-foaming agent can be present in the emulsion. In some embodiments, an anti-foaming agent can be added to the emulsion during or after emulsion formation. The anti-foaming agent can be present in the emulsion in an amount of 0 to 3000 parts per million (ppm), or greater than 0 to 3000 ppm.

Organic solvent is removed from the resulting emulsion. In some embodiments, the organic solvent can be removed by transferring the emulsion into receiving water at a temperature of greater than 40° C. to remove the organic solvent from the emulsion, forming an aqueous slurry. The receiving water can be deionized water, an aqueous buffered solution or water having a pH of 1 to 12. In some embodiments, the receiving water can optionally comprise a surfactant. When present, the surfactant present in the receiving water can be the same or different as the surfactant used in the emulsion. For example, in some embodiments, the receiving water can include an anionic surfactant comprising sodium dodecyl benzene sulfonate, sodium lauryl sulfate, or a combination comprising at least one of the foregoing, preferably sodium dodecyl benzene sulfonate. When present, the surfactant in the receiving water can be in an amount of 0.001 to 3 weight percent, or 0.01 to 1 weight percent, or 0.1 to 0.5 weight percent based on the total weight of the receiving water. In some embodiments, the receiving water can include an anti-foaming agent, for example, in an amount of 0 to 3000 ppm. The anti-foaming agent can be the same of different from the anti-foaming agent that can be included in the emulsion.

The receiving water is maintained at a temperature of greater than or equal to 40° C., preferably 50 to 100° C., more preferably 55 to 95° C., even more preferably 55 to 85° C. to remove the organic solvent (but not a substantial amount of water) and form the slurry comprising a plurality of thermoplastic polymer particles dispersed in the receiving water. In some embodiments, the receiving water temperature can be adjusted to the desired temperature prior to contacting the emulsion with the receiving water, and can be maintained at that temperature during the contacting. In some embodiments, vacuum can also be applied during the transferring or after the transferring to assist in removal of the organic solvent.

In some embodiments, the method can further comprise heating the emulsion up to or below the boiling point of the emulsion prior to transferring the emulsion into the receiving water. In some embodiments, the method can further comprise heating the emulsion above the boiling point of the emulsion prior to transferring the emulsion into the receiving water. When the emulsion is heated to above the boiling point of the emulsion, the heating can be conducted at an elevated pressure, for example, a pressure of 0.001 to 3.44 MPa.

In some embodiments, the emulsion can be transferred to the receiving water in a dropwise manner. In some embodiments, the emulsion can be transferred to the receiving water by spraying through a nozzle.

Alternatively, in some embodiments, the organic solvent can be removed from the emulsion by heating the emulsion to a temperature of greater than 40° C. to remove the organic solvent and form the slurry. For example, the emulsion can be heated to a temperature of 50 to 100° C., or 55 to 95° C., or 55 to 85° C. to remove the organic solvent and form the slurry comprising a plurality of thermoplastic polymer particles.

In some embodiments, greater than 80%, or greater than 90%, or greater than 95%, or greater than 99% of the organic solvent can be removed. In some embodiments, substantially all of the organic solvent can be removed to provide the slurry. Thus, in some embodiments, the slurry can have less than 20%, or less than 10%, or less than 5%, or less than 1%, or less than 0.1% organic solvent after the organic solvent has been removed. In some embodiments, the slurry is devoid of an organic solvent.

In some embodiments, the method can further comprise removing the organic solvent by heating, purging with an inert gas, purging with steam, or a combination comprising at least one of the foregoing, preferably in combination with one of the organic solvent removal techniques described above.

The method further comprises recovering the thermoplastic polymer particles. Recovering the particles can be by centrifuging or filtering the slurry. Filtering can include one or more steps (including a “pre-filtering” step), each step independently using a filter having a desired pore size. For example, recovering the particles can include filtering the dispersion through a filter having an average pore size of 150 micrometers (μm) to remove large particles (e.g., particles having a diameter greater than 150 μm). The filtrate, including particles having a diameter of less than 150 μm, can subsequently be filtered, for example using a filter having an average pore size of 1 μm to provide a wet cake comprising the thermoplastic polymer particles. In some embodiments, the wet cake can be washed one or more times with water, for example the wet cake can be washed with deionized water at a temperature of 25 to 100° C. The wet particles can be washed until a desired level of residual surfactant is reached. For example, the wet particles can be washed with deionized water until the amount of residual surfactant is less than 1000 ppm, or 1 ppb to 1000 ppm, or 1 ppb to 500 ppm, or 1 ppb to 100 ppm, or 1 ppb to less than 25 ppm. In some embodiments, the wet cake can be washed with an organic solvent. In some embodiments, the wet cake can be washed with a mixture comprising an organic solvent and water. When an organic solvent is used, the organic solvent can be, but is not limited to, for example, aliphatic alcohols (e.g., methanol, ethanol, isopropyl alcohol, and the like or a combination comprising at least one of the foregoing), acetone, acetonitrile, or a combination comprising at least one of the foregoing. In some embodiments, the wet cake can be dried, for example by heating, under vacuum, or a combination comprising at least one of the foregoing.

Advantageously, the polymer particles can be recovered in greater than 70% yield, or greater than 75% yield, or greater than 80% yield, or greater than 85% yield, or greater than 90% yield, or 94 to 99.9% yield.

The thermoplastic polymer particles prepared according to the method disclosed herein can exhibit an advantageous combination of properties. In particular, the polymer particles can exhibit an advantageous combination of size characteristics, including narrow and overlapping particle size distributions. Several terms, including Dv10, Dv50, Dv90, Dn10, Dn50, Dn90, and “span” are used herein to further describe the particles prepared according to the above process. The terms “Dv90,” “Dv50,” and “Dv10” refer to 90 volume percent, 50 volume percent, and 10 volume percent, respectively, of the particles having a diameter below the diameter specified. “Dv50” is also referred to as the mean volume based diameter or average volume based diameter. Similarly, the terms “Dn90,” “Dn50,” and “Dn10” refer to 90 percent, 50 percent, and 10 percent (based on number of particles), respectively, of the particles having a diameter below the diameter specified. “Dn50” is also referred to as the mean number based diameter or average number based diameter. The span of the particle size distribution is calculated according to formulas (1) and (2) below:

Span (volume)=(Dv90−Dv10)/Dv50 (1)

Span (number)=(Dn90−Dn10)/Dn50 (2).

In some embodiments, the polymer particles have a Dv100 of less than 150 micrometers, a Dn100 of less than 150 micrometers, or both. In some embodiments, the polymer particles can have a Dv100 of greater than 0 to less than 150 micrometers, or 0.1 to less than 150 micrometers, or 1 to less than 150 micrometers, or 1 to 100 micrometers, or 10 to less than 150 micrometers, or greater than 10 to less than 150 micrometers, or greater than 10 to 75 micrometers or less. In some embodiments, the polymer particles can have a Dn100 of greater than 0 to less than 150 micrometers, or 0.1 to less than 150 micrometers, or 1 to 100 micrometers, or greater than 10 to 75 micrometers or less.

In some embodiments, the polymer particles can have a Dv50 of less than 100 micrometers, a Dn50 of less than 100 micrometers, or both. In some embodiments, the polymer particles can have a Dv50 of greater than 0.1 to less than 100 micrometers. In some embodiments, the polymer particles can have a Dn50 of greater than 0.1 to less than 100 micrometers.

In some embodiments, the polymer particles can have a Dv10 of less than 50 micrometers, or greater than 0.1 micrometer to less than 50 micrometers. In some embodiments, the polymer particles can have a Dn10 of less than 50 micrometers, or greater than 0.1 to less than 50 micrometers.

In some embodiments, the particles can have an average volume-based diameter (Dv50) to average number-based diameter (Dn50) ratio (Dv50:Dn50) of less than 2.0, preferably less than 1.75, more preferably less than 1.5.

In some embodiments, the particles can have a volume-based particle size distribution (span) of less than 2.0, preferably less than 1.5, more preferably less than 1.0. In some embodiments, the particles can have a number-based particle size distribution (span) of less than 2.0, preferably less than 1.5, more preferably less than 1.0.

In some embodiments, the polymer particles are advantageously spherical in shape. For example, the polymer particles can be substantially spherical such that the particles have a sphericity of more than 0.9, preferably more than 0.95. For example, the sphericity can be 0.9 to 1.0, or 0.95 to 1.0. The sphericity is defined by ((6 Vp)/(Dp·Ap)), where Vp is the volume of the particle, Dp is the diameter of the particle, and Ap is the surface area of the particle. The sphericity of the polymer particles can be determined, for example, using scanning electron microscopy (SEM) or optical microscopy imaging techniques.

In some embodiments, the thermoplastic polymer particles can have a bulk density of greater than 0.5 grams per cubic centimeter, or greater than 0.6 grams per cubic centimeter, or greater than 0.7 grams per cubic centimeter. The upper limit varies depending on the polymer used.

In some embodiments, the thermoplastic polymer particles can advantageously comprise less than 25 ppm residual surfactant, for example 0.1 to less than 25 ppm residual surfactant.

In some embodiments, the thermoplastic polymer particles can be mixed with a flow promoter in order to achieve a desired flowability. In some embodiments, the polymer particles can be mixed with a flow promoter in an amount of 0.001 to 1 wt %, or 0.005 to 1 wt %, preferably 0.05 to 0.5 wt %, more preferably 0.05 to 0.25 wt %, based on the weight of the polymer particles. Mixing the particles with the flow promoter can provide particles having a flowability of greater than or equal to 4, preferably greater than or equal to 10. In some embodiments, the flow promoter comprises an unmodified fumed metal oxide, a hydrophobic fumed metal oxide, a hydrophilic fumed metal oxide, hydrated silica, amorphous alumina, glassy silica, glassy phosphate, glassy borate, glassy oxide, titania, talc, mica, kaolin, attapulgite, calcium silicate, magnesium silicate, or a combination comprising at least one of the foregoing. In some embodiments, the flow promoter comprises fumed silica, fumed aluminum oxide, or a combination comprising at least one of the foregoing. In some embodiments, the flow promoter preferably comprises fumed silica. The flow promoter can optionally be a surface modified flow promoter, for example, the flow promoter can comprise hydrophobic or hydrophilic surface modification. Examples of suitable flow promoters that are commercially available include those available under the names SIPERNAT and AEROSIL from Evonik, CAB-O-SIL and CAB-O-SPERSE hydrophilic fumed silica, CAB-O-SIL and CAB-O-SPERSE hydrophobic fumed silica, and CAB-O-SPERSE fumed metal oxide, each available from Cabot Corporation.

In some embodiments, the thermoplastic polymer particles can be prepared so as to comprise one or more additives. For example, the solutions comprising the organic solvent and the thermoplastic polymer can optionally further comprise one or more additives, which can be incorporated into the resulting thermoplastic polymer particles. The one or more additives can include additives that are generally known in the art, with the proviso that the additive(s) are selected so as to not significantly adversely affect the desired properties of the thermoplastic polymer particles described herein. Such additives include a particulate inorganic filler (such as glass, ceramic, or metal, e.g., ceramic particles), a particulate organic filler (such as carbon or a crosslinked polymer), conductive filler (such as graphite or single-walled or multi-walled carbon nanotubes), an inorganic filler, organic fiber, inorganic fiber, conductive ink, antioxidant, heat stabilizer, light stabilizer, ultraviolet (UV) light stabilizer, UV absorbing additive, NIR absorbing additive, IR absorbing additive, laser marking dye, plasticizer, lubricant, release agent (such as a mold release agent), antistatic agent, anti-fog agent, antimicrobial agent, colorant (e.g, a dye or pigment), surface effect additive, radiation stabilizer, flame retardant, anti-drip agent (e.g., a PTFE-encapsulated styrene-acrylonitrile copolymer (TSAN)), a fragrance, or a combination comprising at least one of the foregoing. In general, the additives are used in the amounts known to be effective. For example, the total amount of the additive composition (other than any filler) can be 0.001 to 10.0 wt %, or 0.01 to 5 wt %, each based on the total weight of the thermoplastic polymer particles.

Thermoplastic polymer particles represent another aspect of the present disclosure. The thermoplastic polymer particles can be prepared according to the above-described method.

In an embodiment, thermoplastic polymer particles are disclosed independent of their method of preparation. Thus, an embodiment of the present disclosure is a thermoplastic polymer powder comprising thermoplastic polymer particles having a diameter of less than 150 micrometers, wherein the particles further exhibit an average volume-based diameter (Dv50) to average number-based diameter (Dn50) ratio of less than 2.0, preferably less than 1.75, more preferably less than 1.5; a volume-based particle size distribution of less than 2.0, preferably less than 1.5, more preferably less than 1.0; a number-based particle size distribution of less than 2.0, preferably less than 1.5, more preferably less than 1.0; and a sphericity of greater than 0.9. Such a polymer powder can be prepared according to the methods described herein.

The thermoplastic polymer particles described herein can be used in many applications where particulate, high performance thermoplastic polymers are used, for example in coating application and additive manufacturing. Therefore, an article prepared from the thermoplastic polymer particles represents another aspect of the present disclosure. Advantageously, the thermoplastic polymer particles described herein can be used for the manufacture of various articles including molded articles (e.g., compression molded parts), extruded articles, powder bed fused articles, coatings (e.g., monolayer or multilayer coatings from powder coating, aqueous slurry coating processes, and the like), coated articles, films, additive manufactured parts, thermoplastic composites, thermoplastic laminates, thermoset composites, and the like. In some embodiments, the thermoplastic particles described herein can be useful as additives, for examples as additives in a thermoplastic or thermoset composite, as additives in an adhesive formulation, and the like.

Accordingly, the process of the present disclosure now enables the manufacture of thermoplastic polymer particles having narrow and overlapping particle size distributions in a yield of greater than 70%. Unexpectedly, the relative amounts of water and organic solvent used to prepare the emulsion from which the particles can be obtained can have a significant effect on the size characteristics of the resulting polymer particles. The resulting polymer particles provided by the method described herein exhibit an average volume-based diameter (Dv50) to average number-based diameter (Dn50) ratio of less than 2.0, a volume-based particle size distribution of less than 2.0, a number-based particle size distribution of less than 2.0, and a sphericity of greater than 0.9, and thus can be suitable for a variety of applications that require certain size characteristics, including additive manufacturing and powder coating applications. Accordingly, an improved process for the preparation of polymer particles is provided.

This disclosure is further illustrated by the following examples, which are non-limiting.

### EXAMPLES

In order to demonstrate the process of the present disclosure, thermoplastic polymers such as polyetherimides, polycarbonates, and polysulfones were made into aqueous slurries and spherical powders in high (e.g., >90%) yield by emulsifying the polymer in an organic solvent-water-surfactant mixture, and transferring the emulsion into water to remove the organic solvent. It was unexpectedly discovered that when the amount of water used is significantly reduced compared to the amount of organic solvent used, spherical, fine powders of less than 150 micrometers and having narrow particle size distributions in high yields can be obtained.

As demonstrated by the Comparative Examples below where the formulations used equal volumes of water and organic solvent to generate the emulsions, spherical fine particles having a particle size of less than 150 micrometers when mechanical shaking is used during emulsification do not result, and when rotor/stator mixer is used during emulsification, the resulting particles exhibit a Dv50/Dn50 of greater than 5.0 and a number-based particle size distribution of greater than 2.0.

### Description and Operation

Various thermoplastic polymers were dissolved in an organic solvent such as methylene chloride (DCM) to produce the polymer solution using mechanical shaking. The polymer solution was then emulsified by adding water and surfactant to the polymer solution using varying organic solvent to aqueous ratios. Emulsification was done with high shear agitation (e.g., from 2,800 to 20,000 rpm), resulting in stable emulsion formation.

Organic solvent can be removed from the emulsion to provide an aqueous polymer slurry. One method of forming the aqueous polymer slurry includes slowly adding the emulsion into another reactor which contains water maintained at a temperature of greater than 40° C. The so-called “receiving water” can optionally contain surfactant. The addition of the emulsion into the receiving water can be dropwise or through a nozzle (for the production of fine droplets). The emulsion vessel can be pressurized and heated, if needed. Optionally, anti-foaming agents can be added to the receiving water to minimize the foam during addition of emulsion.

Alternatively, organic solvent can be removed by slowly heating the emulsion, for example using an oil bath. Foaming is preferably minimized by controlling the heating process. Optionally, water, surfactant, or anti-foaming agents can be added to the emulsion. To facilitate the solvent removal, the emulsion can be purged with air, inert gas, or steam.

Once all the organic solvent is removed by either of the above methods, the aqueous slurry was filtered through a 150 micrometer sieve. The polymer particles greater than 150 micrometers which did not pass through the sieve were washed well with water and dried at 105° C. under vacuum for two days to calculate the yield of the process. The aqueous polymer slurry which passed through the 150 micrometer sieve was further filtered through a 1 micrometer filter, washed with water multiple times to remove residual surfactant, and dried at 105° C. under vacuum for two days to produce a dried polymer powder.

### Characterization

Particle size distribution was measured in water using laser diffraction (Mastersizer 3000 from Malvern). The dry polymer powders were made into a slurry in water containing 3000 ppm of anionic surfactant and sonicated for five minutes. The slurry was added to a measurement reservoir containing water. The volume-based particle size distribution and the number-based particle size distribution was measured. The terms “Dv90,” “Dv50,” and “Dv10” refer to 90 volume percent, 50 volume percent, and 10 volume percent, respectively, of the particles having a diameter below the diameter specified. “Dv50” is also referred to as the mean volume based diameter or average volume based diameter. Similarly, the terms “Dn90,” “Dn50,” and “Dn10” refer to 90 percent, 50 percent, and 10 percent (based on number of particles), respectively, of the particles having a diameter below the diameter specified. “Dn50” is also referred to as the mean number based diameter or average number based diameter. The span of the particle size distribution is calculated according to formulas (1) and (2) below:

Span (volume)=(Dv90−Dv10)/Dv50 (1)

Span (number)=(Dn90−Dn10)/Dn50 (2).

Particle morphology was analyzed using optical microscopy. The dry polymer powder was made into a slurry in water. The slurry was spread in a thin layer in a glass plate and allowed to dry. Optical images at 100× magnification were captured through a digital camera attached to the microscope (Olympus).

### Materials

Materials used for the following examples are provided in Table 1.

TABLE 1

| Component | Description |
|---|---|
| PEI-1 | Polyetherimide derived from bisphenol A and meta- |
| | phenylene diamine having a glass transition temperature |
| | of 217° C., obtained at ULTEM 1000 from SABIC |
| PEI-2 | Polyetherimide derived from bisphenol A and meta- |
| | phenylene diamine having a glass transition temperature |
| | of 217° C., obtained as ULTEM 1010 from SABIC |
| PC-1 | Polycarbonate copolymer comprising 2-phenyl-3,3-bis(4- |
| | hydroxyphenyl) phthalimidine (p,p-PPPBP) carbonate and |
| | BPA carbonate repeat units, obtained as LEXAN XHT from |
| | SABIC |
| PC-2 | Polycarbonate obtained as LEXAN C107 from SABIC |
| PSU | Polysulfone derived from the polycondensation of a 4,4′- |
| | dihalodiphenylsulfone and Bisphenol-A; obtained as UDEL |
| | P-1700 NT from Solvay Advanced Polymers, L.L.C. |
| SDBS | Sodium dodecyl benzene sulfonate |
| Water | Deionized water |
| DCM | Methylene chloride |

The thermoplastic polymers listed in Table 1 (in pellet form or as coarse powders) were dissolved in methylene chloride to produce polymer solutions without any suspended particles visible to the unaided eye. To this solution, water and SDBS were added carefully, without disturbing the organic layer. The samples were then emulsified using mechanical shaking at low speed (using an Eberbach model no. E6010.00 mechanical shaker) for 15 minutes, or using stirring with an IKA rotor/stator assembly (IKA T25 Ultra-Turrax with an 18G tool) at a specified speed (rpm) for 5 minutes. The resulting emulsions were transferred dropwise to another flask containing 200 grams of deionized water and 0.2 grams of SDBS (the “receiving water”). The receiving water was maintained at a temperature of greater than 60° C. The receiving flask was constantly agitated using a magnetic stirrer. Foaming in the receiving flask was controlled by the emulsion transfer rate and the optional use of an anti-foaming agent. After complete transfer of the emulsion, the resulting aqueous dispersion was held at greater than 70° C. for an additional 30 minutes to further remove the organic solvent. The aqueous dispersion was then filtered through a 150 micrometer sieve. The particles greater than 150 micrometers in size (e.g., diameter) were washed well with water multiple times, isolated, and dried in a vacuum oven at 105° C. for two days. Yield of polymer particles having a size of less than 150 micrometers was calculated based on the polymer present in 50 grams of emulsion. The examples of the present disclosure are further described in Table 2 below, including the amount of the emulsion components, the aqueous slurry preparation conditions, and characterization of the resulting particles.

As shown in Table 2, examples 1-12 demonstrate that when the amount of water used to form the emulsion is significantly reduced, both mechanical shaking and mixing in a rotor/stator mixer can provide the desired spherical particles. In each of examples 1-12, where 20 grams of water was used (i.e., 10% relative to the amount of DCM), spherical particles having a Dv50/Dn50 of 1.81 or less was obtained. Additionally, both the number and volume spans for these examples were found to be narrow (e.g., 1.34 or less). The yield of particles less than 150 micrometers was also generally greater than 85% for each of examples 1-12. Some examples (e.g., 5, 6, 7, 8, 11, and 12) exhibited both volume and number-based spans of less than 1.

In contrast, examples 13-16 show that when significantly more water was used to form the emulsion (i.e., in a 1:1 ratio of water:DCM), the resulting particles were either isolated in low yield (example 13 and 15), the Dv50/Dn50 was high (examples 14 and 16), or at least one of the number or volume based spans was greater than 2.0 (examples 14 and 16).

Example 17 demonstrates polymer particles obtained by a jet milling process. Particles obtained in this way can have a Dv50/Dn50 and number and volume-based spans of less than 2; however the obtained particles are not spherical.

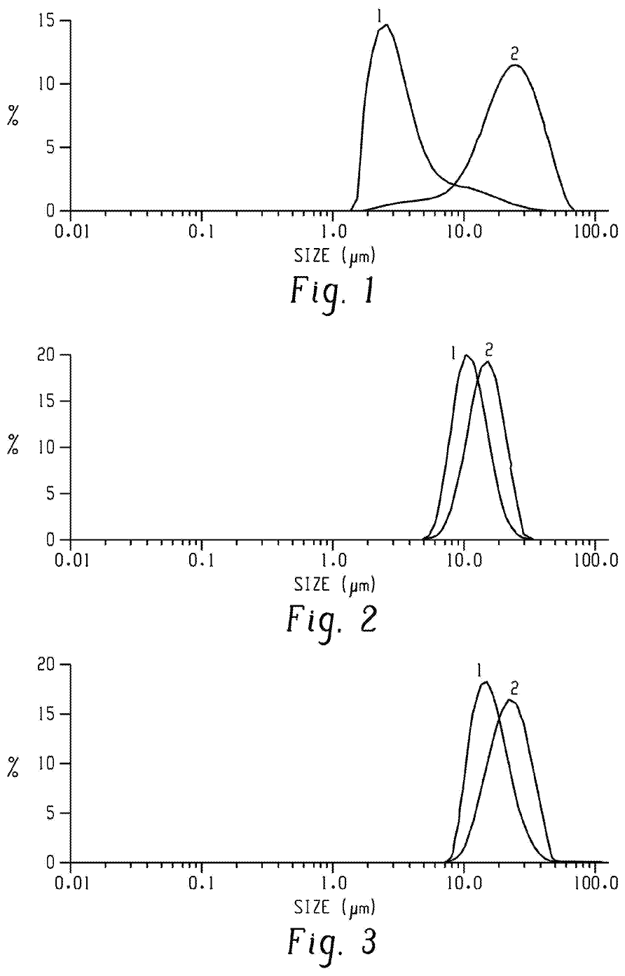

It can be seen for example 14, where the formulation contained equal amounts (by volume) of water and organic solvent, the number based particle size distribution and the volume based particle size distribution are well separated, as shown in FIG. 1, where the distribution labeled “1” is the number based particle size distribution, and the distribution labeled “2” is the volume based particle size distribution.

TABLE 2

| | E1 | E2 | E3 | E4 | E5 | E6 | E7 | E8 | E9 |
|---|---|---|---|---|---|---|---|---|---|
| Polymer | PEI-2 | PEI-2 | PC-1 | PC-2 | PEI-1 | PEI-1 | PEI-1 | PEI-1 | PC-1 |
| Polymer (g) | 50 | 50 | 50 | 50 | 50 | 50 | 64 | 50 | 90 |
| DCM (g) | 200 | 200 | 200 | 200 | 200 | 200 | 200 | 200 | 200 |
| Solids (%) | 20 | 20 | 20 | 20 | 20 | 20 | 24.25 | 20 | 31 |
| Water (g) | 20 | 20 | 20 | 20 | 20 | 20 | 20 | 20 | 20 |
| SDBS (g) | 0.2 | 0.1 | 0.2 | 0.2 | 0.2 | 0.2 | 0.2 | 0.2 | 0.2 |
| Emulsification | IKA | IKA | IKA | IKA | IKA | IKA | IKA | Shaking* | Shaking* |
| Technique | | | | | | | | | |
| Emulsification | 8000 | 5000 | 5000 | 5000 | 3000 | 8000 | 2800 | — | — |
| (rpm) | | | | | | | | | |
| Emulsification | 5 | 5 | 5 | 5 | 5 | 5 | 5 | 10 | 15 |
| time (min) | | | | | | | | | |
| % Yield of | 98.9% | 86.8% | 99% | 60% | 96% | 98.3% | 98.2% | 99.2% | 97.31% |
| particles < 150 μm | | | | | | | | | |
| Particle | Spherical | Spherical | Spherical | Spherical | Spherical | Spherical | Spherical | Spherical | Spherical |
| morphology | | | | | | | | | |
| Dv10 | 2.39 | 4.93 | 2.98 | 3.19 | 3.49 | 2.38 | 3.4 | 13.5 | 22.2 |
| Dv50 | 3.99 | 8.57 | 5.12 | 5.85 | 5.8 | 3.89 | 5.6 | 21.7 | 38.0 |
| Dv90 | 6.46 | 14.8 | 8.57 | 11.0 | 9.21 | 6.2 | 8.87 | 33.9 | 63.7 |
| Dv100 | 9.84 | 27.3 | 12.7 | 27.1 | 12.7 | 8.68 | 12.7 | 51 | 111 |
| Dn10 | 1.75 | 3.55 | 2.16 | 2.15 | 2.47 | 1.77 | 2.41 | 10.3 | 15.8 |
| Dn50 | 2.61 | 5.22 | 3.17 | 3.23 | 3.74 | 2.62 | 3.68 | 15.1 | 23.8 |
| Dn90 | 4.28 | 8.77 | 5.29 | 5.64 | 6.18 | 4.22 | 6.0 | 23.8 | 39.6 |
| Dn100 | 9.43 | 23.8 | 12.5 | 18.6 | 12.6 | 8.61 | 12.6 | 45.5 | 97.9 |
| Span | 1.02 | 1.155 | 1.092 | 1.34 | 0.987 | 0.982 | 0.978 | 0.937 | 1.091 |
| (Volume) | | | | | | | | | |
| Span | 0.969 | 0.998 | 0.989 | 1.082 | 0.993 | 0.939 | 0.975 | 0.896 | 0.998 |
| (Number) | | | | | | | | | |
| Dv50/Dn50 | 1.53 | 1.64 | 1.62 | 1.81 | 1.55 | 1.485 | 1.52 | 1.44 | 1.60 |

| | E10 | E11 | E12 | E13 | E14 | E15 | E16 | E17 |
|---|---|---|---|---|---|---|---|---|
| Polymer | PC-1 | PC-1 | PSU | PEI-1 | PEI-1 | PC-1 | PC-1 | PEI-1 |
| Polymer (g) | 90 | 50 | 50 | 50 | 50 | 50 | 50 | NA |
| DCM (g) | 200 | 200 | 200 | 200 | 200 | 200 | 200 | NA |
| Solids (%) | 31 | 20 | 20 | 20 | 20 | 20 | 20 | NA |
| Water (g) | 20 | 20 | 20 | 200 | 200 | 200 | 200 | NA |
| SDBS (g) | 0.2 | 0.2 | 0.2 | 0.2 | 0.2 | 0.2 | 0.2 | NA |
| Emulsification | IKA | Shaking* | Shaking* | Shaking* | IKA | Shaking* | IKA | NA |
| Technique | | | | | | | | |
| Emulsification | 5000 | — | — | — | 8000 | Shaking* | 2800 | NA |
| (rpm) | | | | | | | | |
| Emulsification | 5 | 15 | 15 | 15 | 5 | 15 | 5 | NA |
| time (min) | | | | | | | | |
| % Yield of | 99.2% | 99.4% | 97.7% | 0.0% | 99% | 0.0% | 99% | NA |
| particles < 150 μm | | | | | | | | |
| Particle | Spherical | Spherical | Spherical | — | Spherical | — | Spherical | Non- |
| morphology | | | | | | | | spherical |
| Dv10 | 3.2 | 9.96 | 14.2 | — | 9.55 | — | 17.6 | 5.64 |
| Dv50 | 5.46 | 14.8 | 22.6 | — | 22.4 | — | 34.5 | 10.3 |
| Dv90 | 9.13 | 21.5 | 34.5 | — | 40.8 | — | 60 | 17.8 |
| Dv100 | 13.2 | 29.6 | 48.5 | — | 66.8 | — | 97.9 | 31.0 |
| Dn10 | 2.40 | 7.85 | 10.9 | — | 1.92 | — | 2.65 | 3.87 |
| Dn50 | 3.48 | 11.2 | 15.7 | — | 2.97 | — | 3.63 | 6.11 |
| Dn90 | 5.75 | 16.7 | 24.8 | — | 8.61 | — | 13.0 | 10.6 |
| Dn100 | 12.6 | 27.3 | 45.5 | — | 54.6 | — | 79.0 | 26.7 |
| Span | 1.086 | 0.775 | 0.898 | — | 1.395 | — | 1.227 | 1.189 |
| (Volume) | | | | | | | | |
| Span | 0.965 | 0.789 | 0.886 | — | 2.253 | — | 2.863 | 1.095 |
| (Number) | | | | | | | | |
| Dv50/Dn50 | 1.57 | 1.32 | 1.44 | — | 7.54 | — | 9.50 | 1.685 |

*Mechanical Shaking

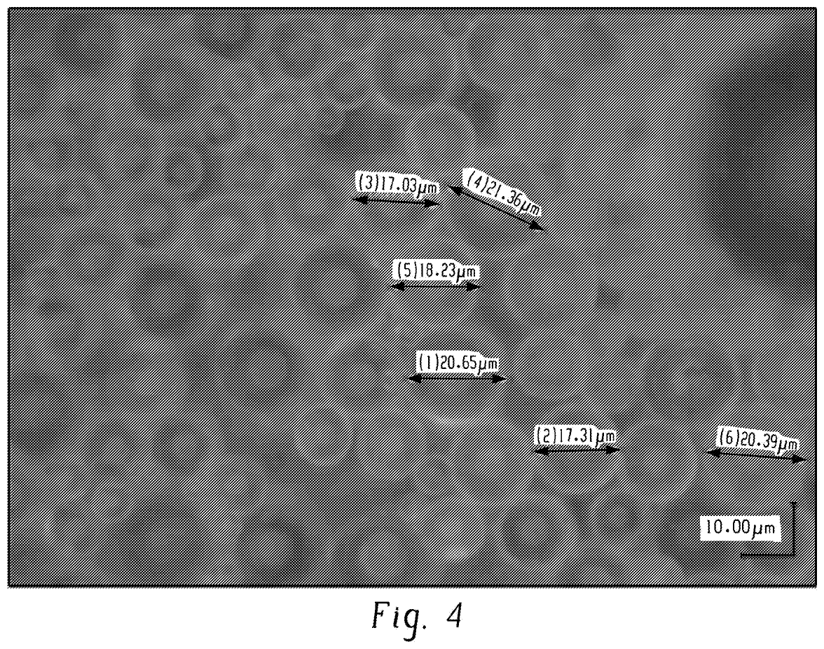

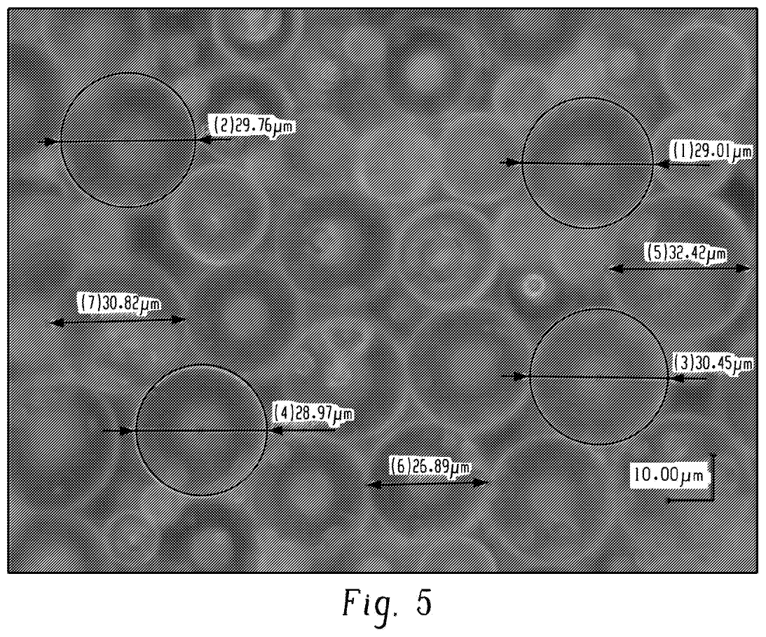

In contrast, for example 11, where the formulation contained a significantly lower amount of water relative to the amount of organic solvent, the number based particle size distribution and the volume based particle size distribution overlap, as can be seen from FIG. 2, where the distribution labeled “1” is the number based particle size distribution, and the distribution labeled “2” is the volume based particle size distribution Similar overlapping in number based particle size distribution and volume based particle size distribution can also be seen in example 12, as shown in FIG. 3, where the distribution labeled “1” is the number based particle size distribution, and the distribution labeled “2” is the volume based particle size distribution. FIG. 4 and FIG. 5 illustrate the spherical morphology of the polymer powders resulting from examples 11 and 12, respectively, as seen by optical microscopy.

Therefore, the above examples demonstrate that aqueous polymer slurries (i.e., dispersions) or dry powders can be prepared in high yields (i.e., greater than 90%) using the present method, where the resulting particles further exhibit the following advantageous combination of properties: a particle diameter below 150 micrometers, are spherical in morphology, exhibit a Dv50/Dn50 of less than 2.0, have a volume-based span of less than 1.4, and a number-based span of less than 1.1.

This disclosure further encompasses the following embodiments, which are non-limiting.

### Embodiment 1

A process for the manufacture of thermoplastic polymer particles in a yield of greater than 70%, the process comprising: dissolving a thermoplastic polymer in an organic solvent capable of dissolving the polymer to form a solution; emulsifying the solution by combining the solution with water and a surfactant to form an emulsion, wherein the water is present in the emulsion in an amount of 5 to less than 50 weight percent, or 5 to 45 weight percent, or 5 to 35 weight percent, or 5 to 30 weight percent, or 5 to 25 weight percent, or 7 to 20 weight percent, or 7 to 15 weight percent, based on the total weight of the water and the organic solvent; removing the organic solvent from the emulsion to form a slurry; and recovering thermoplastic polymer particles in a yield of greater than 70%, wherein the particles exhibit: an average number-based diameter (Dn100), volume-based diameter (Dv100), or both, of less than 150 micrometers, or 0.1 to less than 150 micrometers, or 1 to 100 micrometers, or greater than 10 to 75 micrometers; an average volume-based diameter (Dv50) to average number-based diameter (Dn50) ratio of less than 2.0, preferably less than 1.75, more preferably less than 1.5, even more preferably less than 1.4; a volume-based particle size distribution span of less than 2.0, preferably less than 1.5, more preferably less than 1.0; and a number-based particle size distribution span of less than 2.0, preferably less than 1.5, more preferably less than 1.0.

### Embodiment 2

The process of embodiment 1, wherein removing the organic solvent comprises transferring the emulsion into a receiving water at a temperature of greater than 40° C. to remove the organic solvent and form the slurry.

### Embodiment 3

The process of embodiment 1, wherein removing the organic solvent comprises heating the emulsion to a temperature of greater than 40° C. to remove the organic solvent and form the slurry.

### Embodiment 4

The process of any one or more of embodiments 1 to 3, wherein the particles have a sphericity of greater than 0.9.

### Embodiment 5

The process of embodiment 2, further comprising heating the emulsion up to or below the boiling point of the emulsion prior to transferring the emulsion into the receiving water; or heating the emulsion above the boiling point of the emulsion prior to transferring the emulsion into the receiving water.

### Embodiment 6

The process of any one or more of embodiments 1 to 5, further comprising agitating the solution to form the emulsion.

### Embodiment 7

The process of any one or more of embodiments 1 to 6, wherein the solution has a solids content of greater than 5 weight percent, or greater than 10 weight percent, or greater than 15 weight percent, based on the total weight of the solution.

### Embodiment 8

The process of any one or more of embodiments 1 to 7, wherein the organic solvent has a boiling point of less than 100° C. and is substantially immiscible with water.

### Embodiment 9

The process of any one or more of embodiments 1 to 8, wherein the organic solvent comprises methylene chloride, chloroform, 1,1-dichloroethane, 1,2-dichloroethane, 1,1,1-trichloroethane, or a combination comprising at least one of the foregoing, preferably dichloromethane.

### Embodiment 10

The process of any one or more of embodiments 1 to 9, wherein the thermoplastic polymer comprises polycarbonate, polyimide, polyetherimide, polysulfone, polyethersulfone, polyphenylene sulfone, polyarylene ether, polyarylate, polyamide, polyamideimide, polyester, or a combination comprising at least one of the foregoing, preferably polycarbonate, polyetherimide, polysulfone, or a combination comprising at least one of the foregoing, more preferably polyetherimide.

### Embodiment 11

The process of any one or more of embodiments 1 to 10, wherein the surfactant comprises an anionic surfactant, a cationic surfactant, a nonionic surfactant, or a combination comprising at least one of the foregoing, preferably an anionic surfactant, more preferably sodium dodecyl benzene sulfonate, sodium lauryl sulfate, or a combination comprising at least one of the foregoing.

### Embodiment 12

The process of any one or more of embodiments 1 to 11, further comprising adding an anti-foaming agent to the emulsion.

### Embodiment 13

The process of any one or more of embodiments 1 to 12, further comprising one or more of: filtering the slurry to form a wet cake; pre-filtering the slurry to remove macroparticles or contaminants; washing the wet cake with water; and drying the wet cake under heat and vacuum.

### Embodiment 14

The process of any one or more of embodiments 1 to 13, wherein the emulsion, the slurry, or both further comprise an additive comprising a particulate filler, antioxidant, heat stabilizer, light stabilizer, ultraviolet light stabilizer, UV absorbing additive, NIR absorbing additive, IR absorbing additive, plasticizer, lubricant, release agent, antistatic agent, anti-fog agent, antimicrobial agent, colorant, laser marking additive, surface effect additive, radiation stabilizer, flame retardant, anti-drip agent, a fragrance, a fiber, or a combination comprising at least one of the foregoing; and the recovered particles comprise the additive.

### Embodiment 15

Thermoplastic polymer particles prepared by the process according to any one or more of embodiments 1 to 14.

### Embodiment 16

The thermoplastic polymer particles of embodiment 15, wherein the thermoplastic polymer particles have a bulk density of greater than 0.5 grams per cubic centimeter, of greater than 0.6 grams per cubic centimeter, or greater than 0.7 grams per cubic centimeter.

### Embodiment 17

The thermoplastic polymer particles of embodiment 15 or 16, further comprising a flow promoter in an amount effective to provide a flowability of greater than 4, preferably greater than 10.

### Embodiment 18

The thermoplastic polymer particles of any one or more of embodiments 15 to 17, wherein the particles comprise less than 25 ppm residual surfactant.

### Embodiment 19

A thermoplastic polymer powder comprising thermoplastic polymer particles having a diameter of less than 150 micrometers, wherein the particles have an average volume-based diameter (Dv50) to average number-based diameter (Dn50) ratio of less than 2.0, preferably less than 1.75, more preferably less than 1.5; a volume-based particle size distribution of less than 2.0, preferably less than 1.5, more preferably less than 1.0; a number-based particle size distribution of less than 2.0, preferably less than 1.5, more preferably less than 1.0; and a sphericity of greater than 0.9.

### Embodiment 20

An article prepared from the thermoplastic polymer particles of any one or more of embodiments 15 to 18 or the thermoplastic polymer powder of embodiment 19.

The methods, compositions, and articles can alternatively comprise, consist of, or consist essentially of, any appropriate components or steps herein disclosed. The methods, compositions, and articles can additionally, or alternatively, be formulated so as to be devoid, or substantially free, of any steps, components, materials, ingredients, adjuvants, or species that are otherwise not necessary to the achievement of the function or objectives of the compositions, methods, and articles.

All ranges disclosed herein are inclusive of the endpoints, and the endpoints are independently combinable with each other. “Combinations” is inclusive of blends, mixtures, alloys, reaction products, and the like. The terms “first,” “second,” and the like, do not denote any order, quantity, or importance, but rather are used to distinguish one element from another. The terms “a” and “an” and “the” do not denote a limitation of quantity, and are to be construed to cover both the singular and the plural, unless otherwise indicated herein or clearly contradicted by context. “Or” means “and/or” unless clearly stated otherwise. Reference throughout the specification to “some embodiments,” “an embodiment,” and so forth, means that a particular element described in connection with the embodiment is included in at least one embodiment described herein, and may or may not be present in other embodiments. In addition, it is to be understood that the described elements may be combined in any suitable manner in the various embodiments.

Unless defined otherwise, technical and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

The term “alkyl” means a branched or straight chain, unsaturated aliphatic hydrocarbon group, e.g., methyl, ethyl, n-propyl, i-propyl, n-butyl, s-butyl, t-butyl, n-pentyl, s-pentyl, and n- and s-hexyl. “Alkenyl” means a straight or branched chain, monovalent hydrocarbon group having at least one carbon-carbon double bond (e.g., ethenyl (—HC═CH₂)). “Alkoxy” means an alkyl group that is linked via an oxygen (i.e., alkyl-O—), for example methoxy, ethoxy, and sec-butyloxy groups. “Alkylene” means a straight or branched chain, saturated, divalent aliphatic hydrocarbon group (e.g., methylene (—CH₂—) or, propylene (—(CH₂)₃—)). “Cycloalkylene” means a divalent cyclic alkylene group, —CₙH₂ₙ₋ₓ, wherein x is the number of hydrogens replaced by cyclization(s). “Cycloalkenyl” means a monovalent group having one or more rings and one or more carbon-carbon double bonds in the ring, wherein all ring members are carbon (e.g., cyclopentyl and cyclohexyl). “Aryl” means an aromatic hydrocarbon group containing the specified number of carbon atoms, such as phenyl, tropone, indanyl, or naphthyl. The prefix “halo” means a group or compound including one more of a fluoro, chloro, bromo, or iodo substituent. A combination of different halo groups (e.g., bromo and fluoro), or only chloro groups can be present. The prefix “hetero” means that the compound or group includes at least one ring member that is a heteroatom (e.g., 1, 2, or 3 heteroatom(s)), wherein the heteroatom(s) is each independently N, O, S, Si, or P. “Substituted” means that the compound or group is substituted with at least one (e.g., 1, 2, 3, or 4) substituents that can each independently be a C₁₋₉ alkoxy, a C₁₋₉ haloalkoxy, a nitro (—NO₂), a cyano (—CN), a C₁₋₆ alkyl sulfonyl (—S(═O)₂-alkyl), a C₆₋₁₂ aryl sulfonyl (—S(═O)₂-aryl)a thiol (—SH), a thiocyano (—SCN), a tosyl (CH₃C₆H₄SO₂—), a C₃₋₁₂ cycloalkyl, a C₂₋₁₂ alkenyl, a C₅₋₁₂ cycloalkenyl, a C₆₋₁₂ aryl, a C₇₋₁₃ arylalkylene, a C₄₋₁₂ heterocycloalkyl, and a C₃₋₁₂ heteroaryl instead of hydrogen, provided that the substituted atom's normal valence is not exceeded. The number of carbon atoms indicated in a group is exclusive of any substituents. For example —CH₂CH₂CN is a C₂ alkyl group substituted with a nitrile.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. A process for the manufacture of thermoplastic polymer particles in a yield of greater than 70%, the process comprising:
dissolving a thermoplastic polymer in an organic solvent capable of dissolving the polymer to form a solution;
emulsifying the solution by combining the solution with water and a surfactant to form an emulsion, wherein the water is present in the emulsion in an amount of 5 to less than 50 weight percent, based on the total weight of the water and the organic solvent;
removing the organic solvent from the emulsion to form a slurry; and
recovering thermoplastic polymer particles in a yield of greater than 70%, wherein the particles exhibit:
an average number-based diameter (Dn100), volume-based diameter (Dv100), or both, of less than 150 micrometers;
an average volume-based diameter (Dv50) to average number-based diameter (Dn50) ratio of less than 2.0;
a volume-based particle size distribution span of less than 2.0; and
a number-based particle size distribution span of less than 2.0.

2. The process of claim 1, wherein removing the organic solvent comprises transferring the emulsion into a receiving water at a temperature of greater than 40° C. to remove the organic solvent and form the slurry.

3. The process of claim 1, wherein removing the organic solvent comprises heating the emulsion to a temperature of greater than 40° C. to remove the organic solvent and form the slurry.

4. The process of claim 1, wherein the particles have a sphericity of greater than 0.9.

5. The process of claim 2, further comprising
heating the emulsion up to or below the boiling point of the emulsion prior to transferring the emulsion into the receiving water; or
heating the emulsion above the boiling point of the emulsion prior to transferring the emulsion into the receiving water.

6. The process of claim 1, further comprising agitating the solution to form the emulsion.

7. The process of claim 1, wherein the solution has a solids content of greater than 5 weight percent.

8. The process of claim 1, wherein the organic solvent has a boiling point of less than 100° C. and is substantially immiscible with water.

9. The process of claim 1, wherein the organic solvent comprises methylene chloride, chloroform, 1,1-dichloroethane, 1,2-dichloroethane, 1,1,1-trichloroethane, or a combination comprising at least one of the foregoing.

10. The process of claim 1, wherein the thermoplastic polymer comprises polycarbonate, polyimide, polyetherimide, polysulfone, polyethersulfone, polyphenylene sulfone, polyarylene ether, polyarylate, polyamide, polyamideimide, polyester, or a combination comprising at least one of the foregoing.

11. The process of claim 1, wherein the surfactant comprises
an anionic surfactant, a cationic surfactant, a nonionic surfactant, or a combination comprising at least one of the foregoing.

12. The process of claim 1, further comprising adding an anti-foaming agent to the emulsion.

13. The process of claim 1, further comprising one or more of:
filtering the slurry to form a wet cake;
pre-filtering the slurry to remove macroparticles or contaminants;
washing the wet cake with water; and
drying the wet cake under heat and vacuum.

14. The process of claim 1, wherein
the emulsion, the slurry, or both further comprise an additive comprising a particulate filler, antioxidant, heat stabilizer, light stabilizer, ultraviolet light stabilizer, UV absorbing additive, NIR absorbing additive, IR absorbing additive, plasticizer, lubricant, release agent, antistatic agent, anti-fog agent, antimicrobial agent, colorant, laser marking additive, surface effect additive, radiation stabilizer, flame retardant, anti-drip agent, a fragrance, a fiber, or a combination comprising at least one of the foregoing; and
the recovered particles comprise the additive.

15. Thermoplastic polymer particles prepared by the process according to claim 1.

16. The thermoplastic polymer particles of claim 15, wherein the thermoplastic polymer particles have a bulk density of greater than 0.5 grams per cubic centimeter.

17. The thermoplastic polymer particles of claim 15 or 16, further comprising a flow promoter in an amount effective to provide a flowability of greater than 4.

18. The thermoplastic polymer particles of claim 15, wherein the particles comprise less than 25 ppm residual surfactant.

19. A thermoplastic polymer powder comprising thermoplastic polymer particles having a diameter of less than 150 micrometers, wherein the particles have
an average volume-based diameter (Dv50) to average number-based diameter (Dn50) ratio of less than 2.0;
a volume-based particle size distribution of less than 2.0;
a number-based particle size distribution of less than 2.0; and
a sphericity of greater than 0.9.

20. An article prepared from the thermoplastic polymer particles of claim 15.
